(19) United States
(12) Patent Application Publication
(10) Pub. No.: US 2017/0364848 A1
(43) Pub. Date: Dec. 21, 2017

(54) Wireless device for dynamic risk assessment of sensitive shipments

(71) Applicant: CartaSense Ltd., Petah Tikva (IL)

(72) Inventor: Yaron Kaufmann, Tel-Aviv (IL)

(21) Appl. No.: 15/623,384

(22) Filed: Jun. 15, 2017

Related U.S. Application Data
(60) Provisional application No. 62/351,968, filed on Jun. 19, 2016.

(51) Int. Cl. G06Q 10/06; G06Q 10/08; G06Q 10/04

(52) U.S. Cl. CPC G06Q 10/0635; G06Q 10/047; G06Q 10/083

(57) ABSTRACT

Disclosed is a method for dynamic risk management for shipments using an application, characterized in having a client component embedded in a user communication device, a server component hosted by a server. The method includes actuating, the client component for assessing the risks by a user using an actuation module, receiving the actuation by the server component for initiating assessment of risks associated with the shipment of products based on a plurality of information stored in one or more databases, one or more data sources, and a real time information obtained from shipments, analyzing and determining, one or more control measures to mitigate said assessed risks, and responding back to the client component by the server component using a response module the risks associated with the shipment of products and forecasts on the control measures that the user may adopt to mitigate the assessed risks.

### FIELD OF INVENTION

The present disclosure relates to risk assessment involved with shipments of products, more particularly, the present invention relates to a real time risk assessment, and management system and method for the businesses associated with the shipments of products from one geographical location to another geographical location.

### BACKGROUND

Risk Assessment is all about analyzing external threats against the adopted systems and methods to identify where vulnerabilities may exist, and what control measures can be implemented to reduce such risk.

Many businesses or commercials especially in the field of pharma and food supply work closely with carriers or shippers to assess any risk associated with their products during transportation and determine the level of control or measures they would require ensuring product safety during transportation. The risk assessment helps the businesses identify potential threats for the products safety and adhere to the regulatory compliance challenges.

Conventionally, there exist service providers and consultants that provide shipping lane verification services to ascertain and address threats that could negatively impact quality of food products (for businesses in the food industry) and integrity of pharmaceutical products during transportation. However, the assessments and forecasts of risk by them is not very accurate and reliable. Again, such service providers may not be able to forecast about the measures or controls the businesses should take to mitigate the risk.

There also exist some conventional risk assessment methods, such as Hazard analysis and critical control points (HACCP). It is found increasingly applied to industries other than food, such as cosmetics and pharmaceuticals. Further, it does not seem to provide accurate enough risk assessment for shipment of the products considering the different factors discussed above.

Again, the shipment of the products, namely, the food products and the medicinal products between any two destinations may involve multiple transportation modes and multiple possible routings from one destination to the other. The decision regarding the best mode of transportation and route for transportation of a particular shipment of the products is very complex, involving various factors such as the maximum time the products would remain in the route, conditions of the road (if the products are transported via road), packaging of the products, the weather conditions, and risks of breakages or spoilage of the products. These factors change all the times, especially the weather conditions so proper pre-assessment for the shipments of these products is needed to determine any risks associated with them. At the same time, it is also desired to know about the proper controls or measures one can take to mitigate such risk.

For an instance, shipment of the pharmaceutical products that has short life and may change their state (say solid to liquid) during the transportation and the food items that are subject to lose the nutrients on exposure to the extreme weather conditions is very problematic without pre-assessment of the risks associated with the shipping of such products. Knowing about the possible controls based on the risk assessments to mitigate the risks is also important. For example, in this instance, use of insulated containers in combination with some temperature control mechanism inside container during shipping of such products may be possible control to mitigate the risk.

The lack of real time risk assessment methods has exposed a margin in the shipping business, where packages are larger than needed, insurance premiums are higher than needed, insurance policies are lacking some elements, carbon foot print per shipment is higher than needed and other aspects. All the above factors are causing increased payments and increased loss of freight value. As the world food supply is becoming scarce, this is a major element effecting the basic aspects of our lives.

Due to all these problems discussed above that may arise during shipment of products, the businesses, such as shippers, insurance companies, freight forwarders seem to have increasing demand for a system and method that would in real time assess the risk associated with their shipments from one geographical location to another geographical location.

There is need to facilitate the businesses in reforming their existing services and better serve their potential customers.

### SUMMARY

Real time means a period that is short enough to enable a correction of a risk because an irreparable damage to a product or shipment occurs. For example—real time may be a time period of less that any one of 1-30 minutes, less than an hour and especially less than 1-3 minutes and even less than a minute.

According to an aspect of the present invention there is provided a method for assessing risks associated with shipment of products, and forecasting one or more control measures to mitigate said risks using an application (30), characterized in having a client component (31) embedded in a user communication device (12) and a server component (32) hosted by at least one server (16). The method includes actuating, in said user communication device (12), the client component (31) of said application (30) for assessing said risks associated with shipment of products by a user using an actuation module (33), receiving, by said server component (32) of said application (30) hosted in the at least one server (16), said actuation of the client component (31) of said application (30) for initiating said assessment of risks associated with the shipment of products by the user over a communication network (20).

According to the same aspect, the method further includes assessing, a plurality of risks associated with the shipment of products, by the server component (32) of said application (30) based on the at least one of: a plurality of information stored in at least one database (17), a plurality of information obtained from one or more data sources (18), and a plurality of real time information obtained from shipments (14), analyzing and determining, one or more control measures to mitigate said assessed risks associated with the shipment of products, by the server component (32) of said application (30) based on the plurality of information stored in at least one database (17), the plurality of information obtained from one or more data sources (18), and the plurality of real time information obtained from shipments (14), and responding back to the client component (31) of said application (30), by the server component (32) of said application (30) using a response module (34), with the risks associated with the shipment of products and forecasts on the one or more control measures that the user may adopt to mitigate said assessed risks.

According to another aspect, a system is provided for assessing risks associated with shipment of products, and forecasting one or more control measures to mitigate said risks. The system includes an application (30) for assessing risks associated with shipment of products. The application (30) further comprises a client component (31) and a server component (32) communicatively coupled to each other, a user communication device (12), wherein the client component (31) of said application (30) is embedded, at least one server (16) communicatively coupled to said user communication device (12) over a communication network (20), for hosting the server component (32) of said application (30), and at least one database (17), communicatively coupled to at least one server (16) adapted for storing information provided by different users, a plurality of information obtained from one or more data sources (18), and a plurality of real time information obtained from shipments (14).

According to the same aspect, the server component (32) of said application (30) is configured for assessing a plurality of risks associated with the shipment of products on detecting actuation of an actuation module (33) of the client component (31), and analyzing and determining, one or more control measures to mitigate said assessed risks associated with the shipment of products.

According to another aspect, the system is enabled to receive and process risk assessment request from multiple simultaneous applications either in user terminals related to the users or in other servers that aggregate multiple shipment control.

A key element of the risk assessment process is a device that measures various risk-related parameters and delivers those parameters to the server. It is essential that those parameters will be delivered to the server in real-time or near real-time, so the risk estimate of the shipment can be re-calculated, alerts can be sent to the relevant personnel and corrective actions can be taken.

The device must collect relevant parameters that are indicators for high risk. Those parameters include, but not limited to, temperature, humidity, shock, vibration, tilt, light

A specific wireless device is proposed that make the risk estimation process significantly more reliable and accurate.

The risk estimating device will have the following features
a. Battery operated for relatively long time
b. support more than one communication method to provide connectivity for the internet in various locations.
c. Has multitude of sensors that measure risk indicating parameters.
d. Has the capability to associate the device with a specific pallet, box, or other shipped item.

Keeping a high connectivity to the internet of the risk measurement device is done in a way that maximizes the connectivity and allows maximum savings from risk estimation and loss prevention

The device will include more than one way of communication. At least one method to connect to a WAN (Wide Area Network) (Also known as LPWAN—Low Power WAN). This could be cellular, LORA, SIGFOX, WIMAX or any other technology. At least one method to connect to a LAN (Local area network), this could be Bluetooth, WiFi, ZigBee or proprietary. The device will maximize the connectivity options by acting as a LAN access point when there is WAN connectivity. E.G the device can be connected to the cellular network and act as a WiFi access point to other sensors in the vicinity that might not have cellular connectivity.

As an example, when the devices are in the open, all of them have access to the cellular network, and none of them have access to a LAN. That is the case when they are on the tarmac. In that case all devices will first connect to the cellular network, or other WAN technology like LORA. Once a device is connected to the WAN, it will activate its LAN communication as an access point to allow devices with no WAN access to connect to the internet. A distributed algorithm, embedded in the devices will allow resolving this situation, so that finally only few devices will be connected directly to the internet and the rest will connect to those specific devices. All this is done for the sake of conserving power, as WAN connectivity consumes more power.

As an example, when the devices are in a cold storage in a warehouse with no WAN access, all devices will not be able to connect to the WAN and will search for a LAN connection. Those devices will rely on a local access point that will allow connectivity to the internet. Furthermore, a LAN with mesh capabilities, will allow only one device in the cool room that has connectivity to the access pint to serve as a router and provide internet connectivity to the rest of the sensors in the cool room.

As an example, when all devices are located in a controlled temperature trailer, only one or a few will have WAN connectivity. This connectivity will be intermittent as the trailer is travelling. The devices in the trailer will act as a diversity array, and it can be assumed that during the travel at least one of the devices will get WAN connectivity. Each device, while getting WAN connectivity will act as the access point for the rest of the devices, by establishing a LAN network, with the device connected to the WAN acting as an access point. This will be a dynamic process. When a device no longer has WAN connectivity, it will stop the access point function and revert to look for LAN and WAN connectivity.

Another configuration is to have part of the sensors with LAN communication only, relying on other sensors that are multi-mode to provide them with WAN connectivity. This shipment configuration allows cost reduction for the reduced functionality (LAN only devices)

The association of the device to a shipment is an important aspect of the device operation. The information about the object that the device is attached to is crucial for allowing the personnel to approach a specific high risk item and take corrective actions. Other aspect includes detection of a wrong split of a shipment, where items are mistakenly routed to mistakenly leave in a washhouse. There is a challenge to provide this association, as in most cases the identity of the pallet (meaning a unique number or a charter string) is set completely independent of the attachment of the risk measurement device to the item.

For example, a pallet is built in the shipper's warehouse. Once the pallet build is complete, the shipper will print a label with the pallet unique identification and other information relevant to the pallet shipment and stick the label to the pallet. The risk measuring devices will be applied in a later stage, in a completely independent manner. Uniting the labeling and risk measurement device application will require a major change in the shipper shipping processes and supporting software.

In other cases, the risk measurement device is applied to the pallet in a different location and/or by different personnel, thus preventing of documenting the devices' unique serial number to be associated with the pallet unique serial number

Integration of a reading component in the device, allows the device to read the pallet unique identification and store it in an onboard memory. The device will notify the server about this information and in all further cases, where there is a need to point to a specific tracked item, this item identification information will be used to reference the item

The reading component can be a barcode reader, RFID reader or even a camera. These types of readers are readily available, at a reasonable price and are capable being operated by small batteries.

As a modern communication device, the risk measurement device should include a power source, computing element, memory, a radio component supporting one or more communication modes (LAN and WAN), several sensor components and an optional reader component.

In some cases, as the risk measuring device is being applied to shipment processes that are long established and used by personnel that will require expensive retraining, it is essential to minimize the manual steps required by the users of the device.

The device will include audio and/or visual elements that will allow locating the shipment item easily. When a risk condition is detected an alert (audible and/or visual) will be generated by the device. The user will be guided by should and or light to the shipment item that needs special care to reduce the risk.

There may be provided a method for mitigating risks associated with a shipment of a product, the method may include sensing, by at least one sensor, a sensed risk that may be related to the product; determining in real time, by a computer and based upon a location of the shipment, a risk mitigation measure that requires human intervention and may be related to the shipment of the product; and generating in real time an alert indicating that the human intervention may be required in relation to the shipment of the product.

The risk mitigation measure may be a new route of the shipment, wherein the determining may include calculating the new route based on the sensed risk, the location of the shipment and the destination of the shipment.

The method may include instructing a shipment carrier that carries the product to follow the new route.

The determining of the route for transporting the shipment may be responsive to information related to historical shipments that had already been delivered.

The determining of the route for transporting the shipment may be responsive to information on issues the historical shipments faced with respect to the product.

Any of the sensing may be made by any type of sensors such as image sensors, pressure sensors, strain sensors, accelerometers, speedometers, humidity sensors, temperature sensors, radiation sensors, and the like. Any sensor may be attached to a product, attached to a shipment, included in a product, included in a shipment, located in proximity to a product, located within a shipment carrier, and the like.

The sensing of the sensed risk may include sensing a change in a weather condition.

The sensing of the sensed risk may include sensing a temperature of the product.

The sensing of the sensed risk may include sensing a breakage of packaging of the product.

The sensing of the sensed risk may include sensing a humidity of an environment of the product.

The sensing of the sensed risk may include sensing mechanical shocks related to the product.

The sensing of the sensed risk may include sensing radiation that impinged on the product.

There may be provided a method for mitigating risks associated with a shipment of a product that may be positioned within a shipment, the method may include sensing, by at least one sensor, a sensed risk that may be related to the product; determining in real time, based upon a location of the shipment carrier, a destination of the shipment and the sensed risk, a route for transporting the shipment; and instructing the shipment carrier to follow the route.

The sensing of the sensed risk may include sensing a change in a weather condition.

The sensing of the sensed risk may include sensing a temperature of the product.

The sensing of the sensed risk may include sensing a breakage of packaging of the product.

The sensing of the sensed risk may include sensing a humidity of an environment of the product.

The sensing of the sensed risk may include sensing mechanical shocks related to the product.

The sensing of the sensed risk may include sensing radiation that impinged on the product.

The determining of the route for transporting the shipment may be responsive to information related to historical shipments that had already been delivered.

The determining of the route for transporting the shipment may be responsive to information on issues the historical shipments faced with respect to the product.

There may be provided a method for mitigating risks associated with a shipment of a product, the method may include obtaining identification information that identifies the product or identifies a group of products that includes the product and may be located within the shipment carrier; sensing in real time, by at least one sensor, a sensed risk that may be related to the product; receiving or calculating, risk mitigation information; wherein the risk mitigation information may be calculated in real time, by a computer, and may be based on the identification information and the information about the sensed risk; and generating an alert, in real time, to inform a user about the risk mitigation information.

The computer may be installed in the shipment.

The obtaining of the identification information may include scanning a code with a computerized reader.

The computer may be distant from the shipment, and the method may include transmitting, by a communication module and in real time, the identification information, and the information about the sensed risk, over at least one network and to the computer; and receiving, by the communication module the risk mitigation information.

The computer may be distant from the shipment, and the method may include determining, in a distributed manner a selected communication module out of a group of communication modules that are located in the shipment should transmit outside the shipment the identification information and the information about the sensed risk; transmitting, by the communication module and in real time, the identification information and the information about the sensed risk, outside the shipment and to the computer; and receiving, by the selected communication module, the risk mitigation information.

The sensing of the sensed risk may include sensing a change in a weather condition.

The sensing of the sensed risk may include sensing a temperature of the product.

The sensing of the sensed risk may include sensing a breakage of packaging of the product.

The sensing of the sensed risk may include sensing a humidity of an environment of the product.

The sensing of the sensed risk may include sensing mechanical shocks related to the product.

The sensing of the sensed risk may include sensing radiation that impinged on the product.

The computer may be distant from the carrier, and wherein the method may include transmitting, by a communication module and in real time, the identification information and the information about the sensed risk, over at least one network and to the computer; wherein the transmitting may include attempting to transmit the identification information and the information about the sensed risk using one communication technique; and upon a failure attempting to transmit the identification information and the information about the sensed risk using another communication technique.

Additional aspects and objects of the present invention would appear and become clear as the detail description proceeds with the accompanying drawings.

### BRIEF DESCRIPTION OF THE ACCOMPANYING DRAWINGS

The foregoing summary of aspects, objectives, as well as the following detailed description of preferred embodiments, will be better understood when read in conjunction with the appended drawings. There is shown in the drawings some example embodiments, however, the application is not limited to the specific system and method disclosed in the drawings:

FIG. 1 shows an example of a system and its environment;

FIG. 2 shows an example of a system for assessing risks associated with shipment of products, and forecasting one or more control measures to mitigate said risks;

FIG. 3 shows an example of a risk measuring device allowing to measure shipment specific parameters and transfer them to a server, while keeping high level of connectivity during the shipment travel;

FIG. 4 illustrates an example of a method;

FIG. 5 illustrates an example of a method; and

FIG. 6 illustrates an example of a method.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Any reference in the specification to a system should be applied mutatis mutandis to a method that can be executed by the system.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

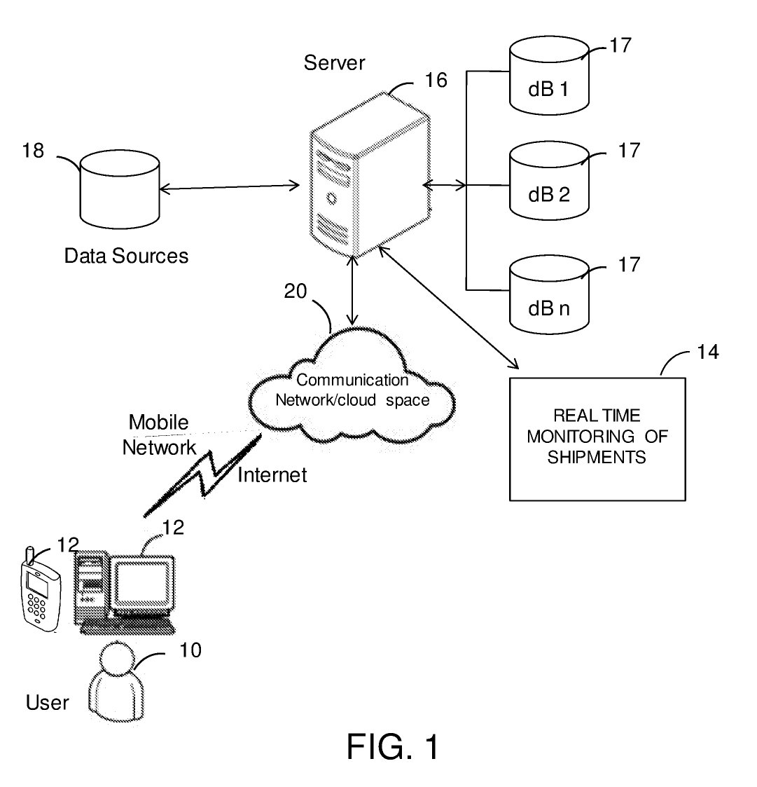

FIG. 1 shows a general conceptual overview of the present invention. As shown, there may be one or more users (10) accessing the system. The system is embodied in the form of an application. Although, only one user (10) is shown illustrated in the figure, it should be understood that multiple users (10) might be accessing and using the system simultaneously. The users (10) may preferably be but not limited to an individual person, or a party such as, shippers, freight forwarders, insurance companies, or even direct businesses (product based companies) that may have facilities to ship the products by themselves from one geographical location to other.

The application may preferably be hosted by at least one server (16) communicatively linked with one or more secure databases (17). The one or more secure databases (17) may preferably include but not limited to information related to accounts of the users (10), information related to historical shipments that had already been delivered, and latest information about the shipment intended to be carried out entered by the user using the communication device (12) held by them.

According to the embodiment, the latest information about the shipment intended to be carried out by the users (10) may preferably include but not limited to a reference number (say an airway bill number (AWB) related to the shipments, information on shipment route (user may enter this information in the electronic form), information on dimensions and packaging of the products, and information on how prone the shipped products are to changes in the weather conditions.

Further as seen, the server (16) may also be communicatively linked to one or more data sources (18) (preferably third party data sources) to keep on updating the data at the databases (17) in order to provide more accurate and reliable analysis of risk associated with the shipment and at the same time enable the system to generate or provide proper measures or controls for the arising risks. The data sources (18) may also hold data or information related to historical shipments that had already been delivered, information on any issues the historical shipments faced with respect to the products and so on. Thus, the information content in the databases (17) would be updated dynamically as soon as information becomes available from the users (10) or from the data sources (18).

The application hosted in the server (16) may preferably be accessible to the users (10) over at least one communication devices (12) associated to the users (10) over a distributed communication network (20). The communication devices (12) may preferably be selected from a group comprising of mobile phone, smart-phone, notebook, laptop, PCs and tablet personal computer.

The system is capable of connecting to the Internet. It should be noted that the term “Internet” is intended to encompass similar systems as well (i.e., World Wide Web or “www”) comprising the capability to communicate and access information through a communication network (20). Examples of types of the communication network include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), an enhanced data GSM environment (EDGE) and a Universal Mobile Telecommunications System (UMTS) and 4G networks (LTE). The present invention should not be limited in its communication nomenclature.

Further, according to some other embodiment, the present system can also be distributed to the individuals/users (10) as a web based platform for a web browser installed on the communication device (12) apart from being available in the form of mobile application.

As further seen in FIG. 1, the system is also enabled to monitor any shipments in real time. Various monitoring means, such as sensors may be installed in the shipment carriers or temporarily be made part of shipment for real time monitoring of any risks. The monitoring means would be able to collect the data from shipment location and share the same with the server (16) in real time. The monitoring means, would be enabled to sense and convey any risks such as change in weather conditions (such as change in temperature, or detection of rainfall etc.), detect any breakages of packaging of the products while loading or unloading the products on and off the containers or ships. This information when received at the server (16) in real time will help in accurate analysis of risks involved and would make the users take appropriate control measures. Based on the real time data obtained at the server (16), the users can also be alerted if any human interventions are needed at the ship or container to mitigate the risks. The alert may preferably be in the form of SMS, email etc. According to the embodiment, the users may register with the system to receive risk based alerts for their shipments. These real time alerts would enable the users to receive a “predictive alert” that their shipment is about to be in a risk and help them take any possible control measure.

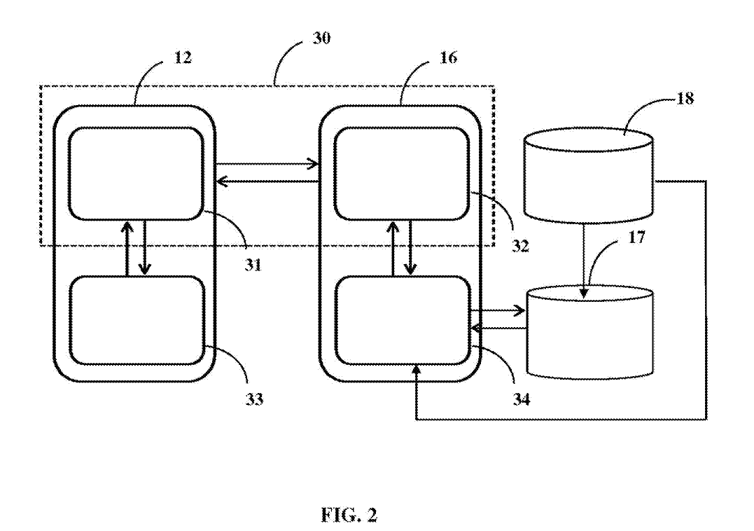

Referring to FIG. 2 is block diagram illustrating architecture of system for assessing risks associated with shipment of products, and forecasting one or more control measures to mitigate said risks. As seen, the system comprises of an application (30). The application (30) further includes of a client component (31) and a server component (32) communicatively coupled to each other. The system further includes a user communication device (12), wherein the client component (31) of the application (30) is embedded, at least one server (16) communicatively coupled to the user communication device (12) over a distributed communication network (20), for hosting the server component (32), and at least one database (17), communicatively coupled to the server (16) adapted for storing information provided by different users, a plurality of information obtained from one or more data sources (18), and a plurality of real time information obtained from shipments (14).

According to the embodiment, the user communication device (12) further comprises of an actuation module (33) adapted for actuating the client component (31) of the application (30) by the user for assessing risks associated with shipment of products, and forecasting one or more control measures to mitigate said risks.

According to the embodiment of the present invention, the server component (33) of the application (30) hosted on the server (16) receives the actuation of the client component (31) and on receiving the actuation initiates the assessment of risks associated with the shipment of products over the communication network (20).

In another embodiment, the server (16) further includes a response module (34) adapted for analyzing, determining, and responding to the client component (31) of the application (30), with information on a plurality of risks associated with the shipment of products, and forecasts the one or more control measures that the user may adopt to mitigate the assessed risks.

In another embodiment, the client component (31) and corresponding actuation of the application may also be performed by another server (not shown) in communication with the server 16 (to enable server to server, or B2B type of transactions) when a business entity requests for a risk assessment service and is served by the risk assessment system described in this disclosure.

Upon analyzing the collective data, the assessed risks and control measures forecast for the current intended shipment would be delivered to the user in a user friendly manner, such as in a plain textual form, in a tabular form, in the form of visual images or any combinations thereof.

The assessed risks may include but not limited to the chance of losing a shipment (long temperature excursion) or a certain drop in the estimated value of the shipment on arrival at the destination. The risk assessment report would preferably outline the historical performance of similar shipments, performance of various carriers for similar shipments, the required weather condition information for similar shipment and other varying parameters like the pre-conditioning quality of the shipment, extensive exposure to direct sun light, extreme weather conditions and the like

According to the same embodiment, the system is further able to deliver risk assessment for the route planning for each shipment.

The forecasts for the control measures may be for example, the best route to transport the products, the best mode to ship the products, the best performing shippers or carriers, the best time or best weather condition parameters for shipping that would greatly be used by potential customers or businesses ship the products from one geographical region to other.

According to the embodiment, the risk assessment, determination and forecasting of control measures is based on analysis of a plurality of information stored in at least one database (17), a plurality of information obtained from one or more data sources (18), and a plurality of real time information obtained from shipments (14).

According to the embodiment, the information stored in the databases (17) may preferably include but not limited to information related to accounts of the users, information related to historical shipments that had already been delivered, and any latest information about the shipment intended to be carried out. The latest information about the shipment intended to be carried out by the users may preferably be but not limited to a reference number (say an airway bill number (AWB) to the shipments, information on shipment route, information on dimensions and packaging of the products, information on how prone the products are to the change in weather conditions.

According to the same embodiment, the information obtained from one or more data sources (18) may include but not limited to information related to historical shipments that had already been delivered and stored in the third party databases, information on any issues the historical shipments faced with respect to the shipments of similar products for the same destination.

According to the embodiment, the real time information obtained from shipments may preferably include information captured and transferred by various monitoring means, such as sensors that may be installed in the shipment carriers or be temporarily made part of shipment for real time monitoring. Such monitoring means would be able to collect the data from shipment location and share the same with the server (16) in real time. The data collected by them may preferably be information on any change in the weather conditions (such as change in temperature, or detection of rainfall etc.), breakages of packaging while loading or unloading the products on and off the containers or ships. This information when received at the server (16) in real time will help in accurate analysis of risks involved and would enable the users to take appropriate control measure. Based on the real time data obtained at the server (16), the users can also be alerted if any human interventions are needed at the ship or container to mitigate the risks.

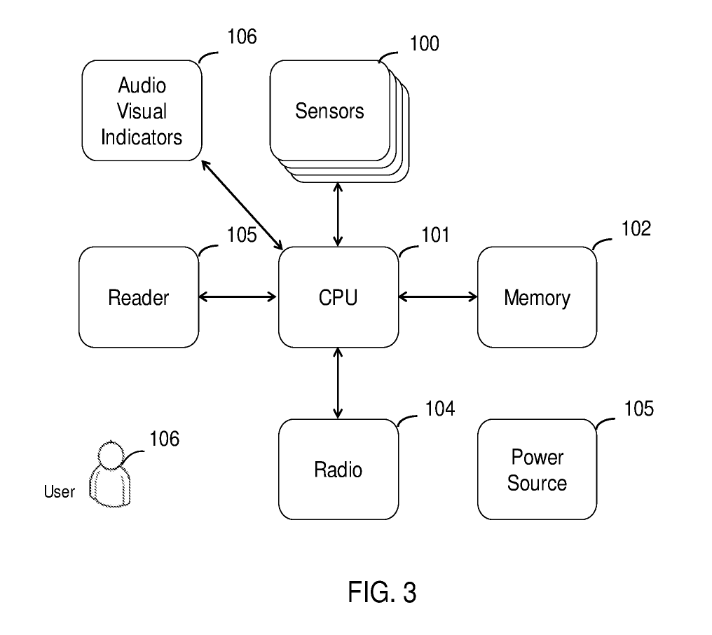

FIG. 3 shows a block diagram of the risk measuring device. The device is powered by a power source (105). This power source can be a battery, a large capacitor, solar cell, or other power sources.

A central processing unit (101) is fetching an embedded program code from the memory (102) to perform the needed functionality of the device. The memory block (102) contains both program memory, data memory and a nonvolatile memory allowing storage of configurable parameters

The radio block (104) contains a single or multiple transceivers, allowing communication with WAN and LAN. The WAN connectivity allows connection to the WAN. The LAN connectivity allow the unit to function both as a client, connecting to a LAN access point or as a LAN access point.

According to the embodiment, The CPU (101), by executing the program stored in the memory block (102) reads information from the sensors about the physical parameters of the shipment like temperature, humidity, shock, vibration, light, gases, and others and stores them in the memory block (102). Another functionality of the CPU block (101) is to modify the radio block (104) to provide the device with the best connectivity. This could be activating only WAN connectivity, or alternatively only LAN connectivity or alternatively both WAN and LAN.

According to the embodiment, in case of a detected risk, the CPU (101), either autonomously or by remote command from the server will activate the all or part of the audiovisual indicators (106).

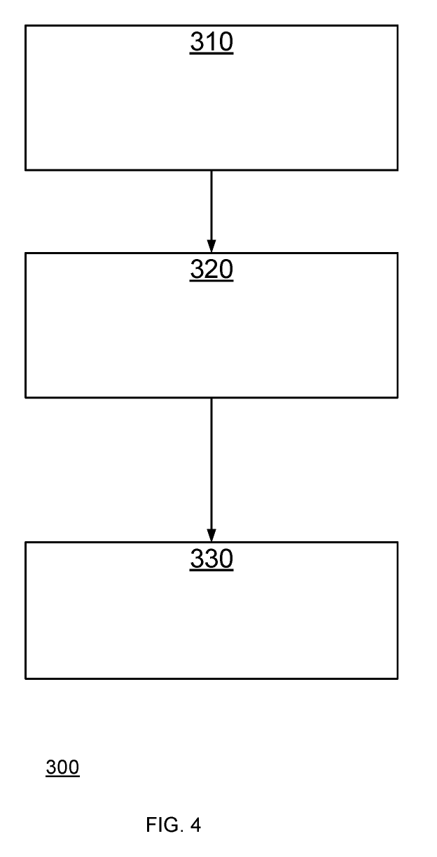

FIG. 4 illustrates method 300 for mitigating risks associated with a shipment of a product, the method may include:
a. Sensing, by at least one sensor, a sensed risk that is related to the product (310).
b. Determining in real time, by a computer and based upon a location of the shipment, a risk mitigation measure that requires human intervention and is related to the shipment of the product (320).
c. Generating in real time an alert indicating that the human intervention is required in relation to the shipment of the product (330).

The risk mitigation measure may be a new route of the shipment, and step 320 may include calculating the new route based on the sensed risk, the location of the shipment and the destination of the shipment.

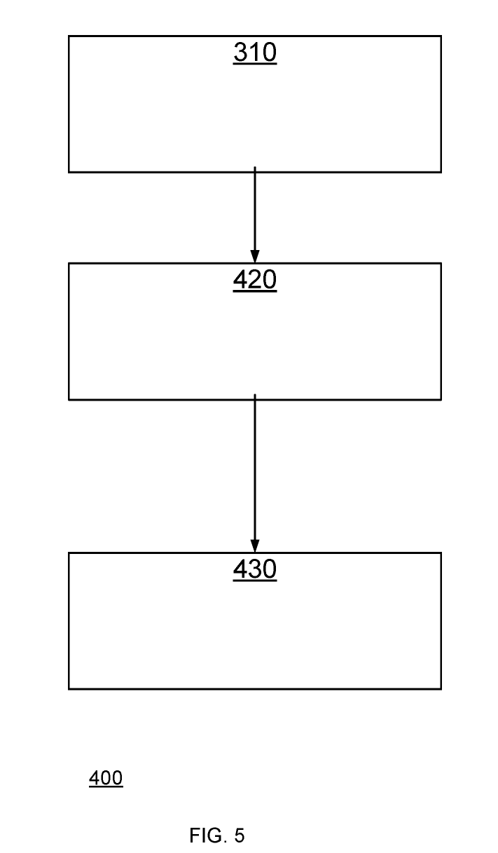

FIG. 5 illustrates method 400 for mitigating risks associated with a shipment of a product, the method may include:
a. Sensing, by at least one sensor, a sensed risk that is related to the product (310).
b. Determining in real time, based upon a location of the shipment carrier, a destination of the shipment and the sensed risk, a route for transporting the shipment (420).
c. Instructing the shipment carrier to follow the route (430). The instructing may include controlling an autonomous driving system of the shipment carrier to follow the route.

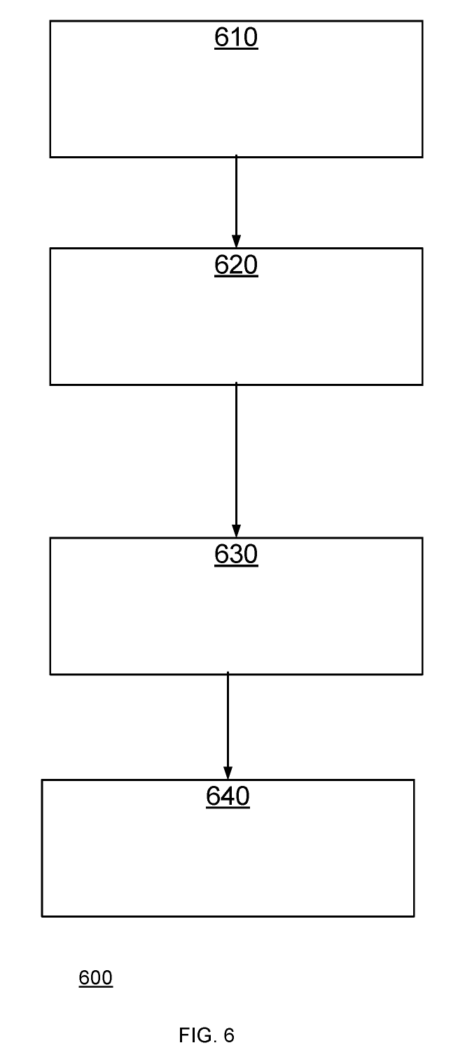

FIG. 6 illustrates method 600 for mitigating risks associated with a shipment of a product, the method may include:
a. Obtaining identification information that identifies the product or identifies a group of products that includes the product and is located within the shipment carrier (610).
b. Sensing in real time, by at least one sensor, a sensed risk that is related to the product (620).
c. Receiving or calculating, risk mitigation information; wherein the risk mitigation information is calculated in real time, by a computer, and is based on the identification information and the information about the sensed risk (630).
d. Generating an alert, in real time, to inform a user about the risk mitigation information (640). The alert may be a human perceivable alert.

According to the embodiment, the reader block (105), either automatically, or by user command, will scan for a readable shipment item ID like a barcode, RFID or others and will transfer this information to the CPU (101) block. The CPU (101) stores this shipment item information in the memory block (102) either in the data memory or in the nonvolatile memory.

Although the above foregoing description doesn't mention or describes about the nature of product specifically, however, it should be understood by those skilled in the art, the current risk management method and system for the shipments can be employed for several categories of products which may be prone to change in weather conditions, regulatory compliance where they are shipped. Example of such products includes but not limited to pharmaceutical products, food products, cosmetics, sensitive technical equipment, and the like.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “rear” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between various components are merely illustrative and that alternative embodiments may merge various components or impose an alternate decomposition of functionality upon various components. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” Each other such that the desired functionality is achieved, irrespective of architectures or intermedial components. Likewise, any two components so associated can also be viewed as being “operably connected,” or “operably coupled,” to Each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for mitigating risks associated with a shipment of a product, the method comprises: sensing, by at least one sensor, a sensed risk that is related to the product; determining in real time, by a computer and based upon a location of the shipment, a risk mitigation measure that requires human intervention and is related to the shipment of the product; and generating in real time an alert indicating that the human intervention is required in relation to the shipment of the product.

2. The method according to claim 1 wherein the risk mitigation measure is a new route of the shipment, wherein the determining comprises calculating the new route based on the sensed risk, the location of the shipment and the destination of the shipment.

3. The method according to claim 2 further comprising instructing a shipment carrier that carries the product to follow the new route.

4. The method according to claim 2 wherein the determining of the route for transporting the shipment is responsive to information related to historical shipments that had already been delivered.

5. The method according to claim 4 wherein the determining of the route for transporting the shipment is responsive to information on issues the historical shipments faced with respect to the product.

6. The method according to claim 1 wherein the sensing of the sensed risk comprising sensing a change in a weather condition.

7. The method according to claim 1 wherein the sensing of the sensed risk comprising sensing a temperature of the product.

8. The method according to claim 1 wherein the sensing of the sensed risk comprising sensing a breakage of packaging of the product.

9. The method according to claim 1 wherein the sensing of the sensed risk comprising sensing a humidity of an environment of the product.

10. The method according to claim 1 wherein the sensing of the sensed risk comprising sensing mechanical shocks related to the product.

11. (canceled)

12. A method for mitigating risks associated with a shipment of a product that is positioned within a shipment, the method comprises: sensing, by at least one sensor, a sensed risk that is related to the product; determining in real time, based upon a location of the shipment carrier, a destination of the shipment and the sensed risk, a route for transporting the shipment; and instructing the shipment carrier to follow the route.

13. (canceled)

14. (canceled)

15. (canceled)

16. (canceled)

17. (canceled)

18. (canceled)

19. The method according to claim 12 wherein the determining of the route for transporting the shipment is responsive to information related to historical shipments that had already been delivered.

20. The method according to claim 12 wherein the determining of the route for transporting the shipment is responsive to information on issues the historical shipments faced with respect to the product.

21. A method for mitigating risks associated with a shipment of a product, the method comprises: obtaining identification information that identifies the product or identifies a group of products that includes the product and is located within the shipment carrier; sensing in real time, by at least one sensor, a sensed risk that is related to the product; receiving or calculating, risk mitigation information; wherein the risk mitigation information is calculated in real time, by a computer, and is based on the identification information and the information about the sensed risk; and generating an alert, in real time, to inform a user about the risk mitigation information.

22. The method according to claim 21, wherein the computer is installed in the shipment.

23. The method according to claim 21 wherein the obtaining of the identification information comprises scanning a code with a computerized reader.

24. The method according to claim 21, wherein the computer is distant from the shipment, and the method comprises: transmitting, by a communication module and in real time, the identification information, and the information about the sensed risk, over at least one network and to the computer; and receiving, by the communication module, the risk mitigation information.

25. The method according to claim 21, wherein the computer is distant from the shipment, and the method comprises: determining, in a distributed manner a selected communication module out of a group of communication modules that are located in the shipment should transmit outside the shipment the identification information and the information about the sensed risk; transmitting, by the communication module and in real time, the identification information, and the information about the sensed risk, outside the shipment and to the computer; and receiving, by the selected communication module, the risk mitigation information.

26. The method according to claim 21 wherein the sensing of the sensed risk comprising sensing a change in a weather condition.

27. (canceled)

28. (canceled)

29. (canceled)

30. The method according to claim 21 wherein the sensing of the sensed risk comprising sensing mechanical shocks related to the product.

31. (canceled)

32. The method according to claim 21, wherein the computer is distant from the carrier, and wherein the method comprises: transmitting, by a communication module and in real time, the identification information, and the information about the sensed risk, over at least one network and to the computer; wherein the transmitting comprises attempting to transmit the identification information and the information about the sensed risk using one communication technique; and upon a failure attempting to transmit the identification information and the information about the sensed risk using another communication technique.
